(19) United States
(12) Patent Application Publication
(10) Pub. No.: US 2008/0297124 A1
(43) Pub. Date: Dec. 4, 2008

(54) Transmission method, apparatus and module

(76) Inventors: Jyrki Koljonen, Salo (FI); Tapani Ekman, Salo (FI); Pekka Mellanen, Marttila (FI); Simo Murtojarvi, Salo (FI); Jori Arrakoski, Espoo (FI)

Correspondence Address: SQUIRE, SANDERS & DEMPSEY L.L.P., 8000 TOWERS CRESCENT DRIVE, 14TH FLOOR, VIENNA, VA, 22182-6212, US

(21) Appl. No.: 11/878,118

(22) Filed: Jul. 20, 2007

(30) Foreign Application Priority Data
May 30, 2007 (FI) 20075393

(51) Int. Cl. G05F 1/66

(52) U.S. Cl. 323/234

(57) ABSTRACT

The invention is related to an apparatus configured to: monitor a power supply voltage and a transmission power need and adjust transmission power according to the power supply voltage and the transmission power need for prolonging operation time of an electronic device when the power supply voltage is at least the same as a predetermined limiting value set for a power supply voltage of the electronic device.

### FIELD

The invention relates to a transmission method, an apparatus and a module.

### BACKGROUND

A radio channel changes constantly as a function of time. For instance, as a user device moves, changes in a multipath propagation environment cause changes in the radio channel. It is important to adapt the transmission power level of an electronic device such that the signal level is sufficient for network elements to receive and detect the signal, and that it causes as little interference as possible to other users of the system.

Transmitters use power amplifiers for adjusting the transmission power to a desired level. Output powers of the amplifiers are adjusted as the radio channel changes and/or according to the distance between a transmitter and a receiver.

Industry is nowadays looking for improved user experience by extended operation times of electronic devices. The tendency is to make the electronic devices capable of operating with as low supply voltages as possible so as to answer this challenge. However, low supply voltages cause problems since high transmission powers have to be generated from the supply voltages. Thus, voltage up-converters between a power supply and a transmitter circuitry have been introduced.

The use of voltage up-converters may lead to a situation in which when a power supply voltage decreases due to discharge, peak currents taken from the power supply increase. The high currents together with internal power supply resistances cause the power supply voltage to decrease further. This, in turn, may disturb the operation of other circuitries and furthermore make the electronic device shut down before the full power supply capacity has been utilized.

### BRIEF DESCRIPTION

According to an aspect of the present invention, there is provided a method as specified in claim 1.

According to another aspect of the present invention, there is provided an apparatus as specified in claims 5 and 13.

According to another aspect of the present invention, there is provided a module as specified in claims 9 and 15.

### LIST OF DRAWINGS

In the following, the invention will be described in greater detail with reference to the embodiments and the accompanying drawings, in which

FIG. 1 shows an example of a communication system,

FIG. 2 is a flow chart,

FIG. 3 illustrates an example of a power adjusting arrangement,

FIG. 4 shows an example of a voltage up-converter, and

FIG. 5 is an example of an electronic device.

### DESCRIPTION OF EMBODIMENTS

Many different radio protocols to be used in communications systems exist. Some examples of different communication systems are the Universal Mobile Telecommunications System (UMTS) radio access network (UTRAN), Global System for Mobile Communications (GSM) and its modifications, Wireless Local Area Network (WLAN), Worldwide Interoperability for Microwave Access (WiMAX), Bluetooth®, Personal Communications Services (PCS) and systems using ultra-wideband (UWB) technology.

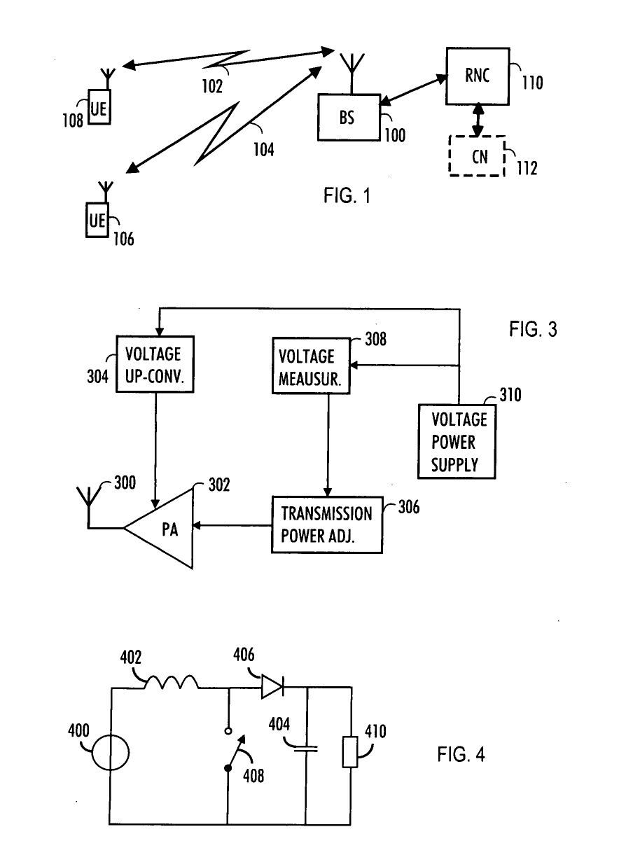

FIG. 1 is a simplified illustration of a communications system to which embodiments according to the invention are applicable. FIG. 1 shows a part of a UMTS radio access network (UTRAN). UTRAN is a radio access network which includes wideband code division multiple access (WCDMA) technology.

The communications system is a cellular radio system which comprises a base station (or node B) 100, which has bi-directional radio links 102 and 104 to user devices 106 and 108. The user devices may be fixed, vehicle-mounted or portable. The base station includes transceivers, for instance. From the transceivers of the base station, a connection is provided to an antenna unit that establishes bi-directional radio links to the user devices. The base station is further connected to a controller 110, a radio network controller (RNC), which transmits the connections of the devices to the other parts of the network. The radio network controller controls in a centralized manner several base stations connected to it. The radio network controller is further connected to a core network 112 (CN). Depending on the system, the counterpart on the CN side can be a mobile services switching center (MSC), a media gateway (MGW) or a serving GPRS (general packet radio service) support node (SGSN), etc.

It should be noted that in future radio networks, the functionality of an RNC may be distributed among (possibly a subset of) base stations.

The embodiments are not, however, restricted to the system given as an example but a person skilled in the art may apply the solution to other communication systems provided with the necessary properties. Different radio protocols may be used in the communication systems in which embodiments of the invention are applicable. The radio protocols used are not relevant regarding the embodiments of the invention.

The communication system is also able to communicate with other networks, such as a public switched telephone network or the Internet.

An embodiment of the invention prevents peak currents thus prolonging the operation time of an electronic device. Further, the embodiment decreases unpredictable behaviour of power supplies such as batteries.

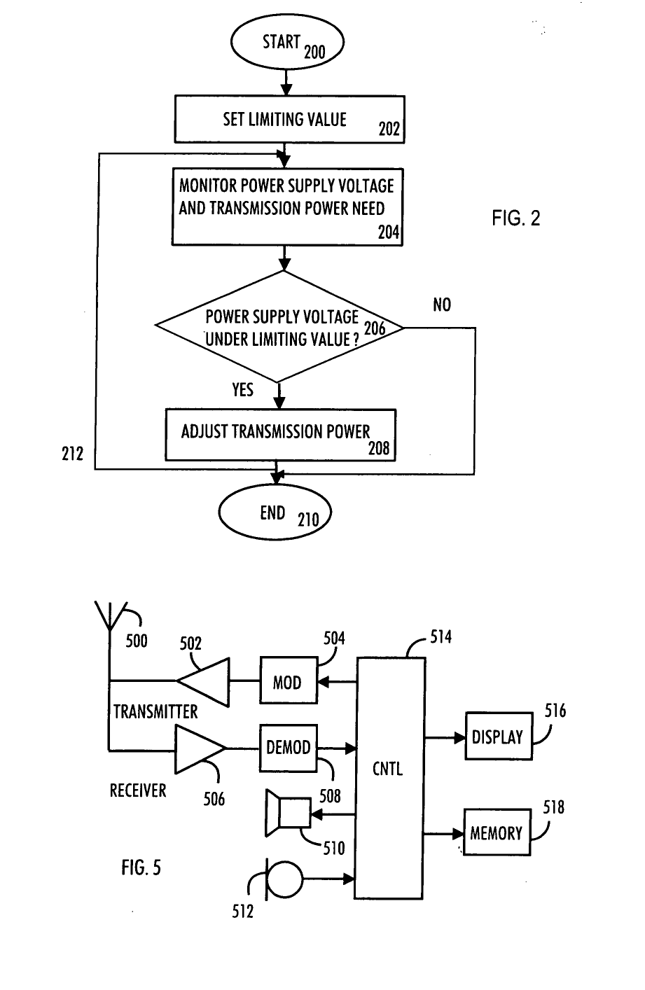

FIG. 2 is a flow chart depicting an embodiment of a transmission method.

The embodiment starts in block 200. In block 202, a limiting value for a power supply voltage of an electronic device is set. This value may be thought to be a lower limit for the voltage of a power supply launching adjustment of transmission power. The limiting value typically depends on a power supply in question and thus limiting values are product-specific. The limiting value may for instance depend on the characteristics of a transmitter: the quality of a signal may deteriorate, if a voltage level is low and a need to obtain a lot of power exists. Another affecting factor may be the efficiency of a power source: the estimated level of current peaks. Yet another affecting factor may be the sensitivity of the parts of the electronic device to changes in the power level. In block 204, the power supply voltage and a transmission power need are monitored. The power supply voltage is typically monitored by measuring. The monitoring provides information on the power supply voltage, which varies over time, generally decreasing during operation of an electronic device.

The transmission power need is monitored. Many transmission power monitoring options exist.

Transmission power is usually adapted according to circumstances. For example in the GSM, the network defines a power level for a device to use for transmission. This power level includes a certain tolerance window within which the device has a possibility to adjust its transmission power, for example for prolonging operation time.

Monitoring actual transmission power offers an option to compare the actual transmission power and the needed (defined) power. This information may be used in determining opportunities to decrease transmission power.

One transmission power monitoring option is based on stored information on the ratio of the amplification (or gain) of a power amplifier and a supply voltage. Another option is to use of a power detector which may be integrated into the power amplifier or implemented as a separate component before an antenna.

If the power supply voltage drops below the limiting value 206, transmission power is adjusted according to the power supply voltage and the transmission power need for prolonging electronic device's operation time (block 208). Typically, the transmission power is gradually lowered according to the diminishing power supply voltage within the range of a predetermined power level. For instance, in the GSM specification, the range within each power level is typically +/−2 dB to +/−6 dB.

The embodiment ends in block 210.

The embodiment is repeatable. One example of repetition possibilities is depicted by arrow 212. Monitoring the power supply voltage and transmission power need is typically continued constantly or periodically until the operation of the electronic device is switched off. The limiting value may be set only once, for instance during manufacture, or it may be up-datable, for instance when the power supply is changed to one having bigger or smaller capacity.

Adjustment needs typically occur only in connection with relatively high power levels. Thus, a value for an upper limit for the needed transmission power may be set. The upper limit then acts as a decision criterion to determine whether or not to carry out adjustment.

Further, a limiting value for a power supply voltage may also be set. This value then serves as a lower limit for the voltage of a power supply for launching the adjustment procedure.

It is also an option to combine the adjustment procedure with ramping up the transmission power gradually.

FIG. 3 illustrates an example of a power adjusting arrangement.

A transmitter includes an antenna unit 300 and a power amplifier 302. The antenna unit may comprise one antenna element or a plurality of antenna elements. Antennas as well as power amplifiers are well known in the art and thus not explained in further detail herein.

A voltage up-converter 304 is arranged to adjust a supply voltage of the power amplifier 302 in such a way that the supply voltage of the power amplifier is high enough despite of a power supply voltage. Typically, the power of the power amplifier is limited when the power supply voltage is diminishing. Voltage up-converters are, for example, switched-mode power supplies which may be used to raise the power amplifier's supply voltage higher than the voltage of the power supply 310 itself. This raise-up is typically carried out when relatively high transmission powers are required. Namely, in these cases, low power supply voltages are usually not enough for power amplifier needs.

Portable electronic devices typically use batteries, solar panels, etc, as power supplies. Transfer of a voltage obtained from such a power supply to a voltage suitable for the current need is typically carried out by using a voltage up-converter also called a boost converter or a step-up converter. A voltage up-converter is a DC to DC converter (DC is an abbreviation for direct current) with an output voltage higher than the voltage obtained from the power supply.

FIG. 4 illustrates one example of a typical voltage up-converter. A power supply 400 may be a battery. 402 is an inductor and 404 is a capacitor. The exemplary voltage up-converter also includes at least two switches 406, 408 and a load 410.

To prevent or at least diminish the above-mentioned undesired effect of the current consumption increasing according to increasing transmission power, a voltage measurement device is introduced. Hence, a transmission power adjusting circuitry 306 may obtain information on the power supply voltage, which varies over time generally decreasing during operation of an electronic device. The voltage measurement device may also convey information on the state of the power supply to the voltage up-converter.

The transmission power adjusting circuitry 306 typically takes care of generating an input signal to the power amplifier and adjusting the transmission power of the electronic device. The transmission power adjustment circuitry may adjust the transmission power on the basis of the voltage measurements carried out in block 308.

The transmission power adjusting circuitry can be implemented as a combination of a radio frequency application specific integrated circuit (ASIC) designed to process low-level signals, a digital base band ASIC and appropriate software.

On the basis of the information on the power supply voltage and the needed transmission power, the transmission power adjusting circuitry adjusts transmission power. Typically, the transmission power is gradually lowered according to the diminishing power supply voltage within the range of a predetermined power level. For instance, in the GSM specification, the range within each power level is typically +/−2 dB to +/−6 dB.

The transmission power adjusting circuitry controls the power amplifier and/or voltage up-converter for adjusting the transmission power.

Adjustment needs typically occur only in connection with relatively high power levels. Thus, a value of an upper limit for the needed transmission power may be set. The upper limit then acts as a decision criterion to determine whether or not to carry out the adjustment.

Further, a limiting value for a power supply voltage may also be set. This value then serves as a lower limit for the voltage of a power supply launching the adjustment procedure.

It is also an option to combine the adjustment procedure with ramping up the transmission power gradually.

The power adjusting arrangement may be implemented as a module or a part of another module or unit. A module may be implemented as a chip set.

The power adjusting arrangement may be implemented as one or more digital signal processors (components) provided with suitable software or it may be implemented by using separate logic circuits, such as ASICs (Application Specific Integrated Circuit). The power adjusting arrangement may also be a combination of these two implementations, such as a processor with suitable software embedded within an ASIC.

FIG. 5 shows a simplified example of a user device whereto the embodiments of the invention are applicable. The user device may be a mobile telephone, a laptop, a multimedia device or a personal digital assistant, for example, without being restricted thereto. The user device may be any device capable of receiving information and/or transmitting information. The user device is herein taken as an example of an apparatus.

The user device comprises an antenna 500 with which signals are both transmitted and received via a duplex filter.

The user device further comprises a transmitter for a wireless telecommunication system 502, to amplify and transmit a modulated signal to the antenna, a modulator 504 modulating the carrier wave by a data signal comprising the desired information in accordance with a selected modulation method, a receiver 506 which amplifies the signal supplied from the antenna and down-converts the signal to a selected intermediate frequency or directly to baseband, and a demodulator 508 demodulating the received signal to enable a data signal to be separated from the carrier wave.

The user device also comprises a controller block 514 comprising, for example, control and calculation means for controlling the operation of the different parts of the user device, means for processing the speech of the user or the data generated by the user, such as a digital signal processing (DSP) processor comprising, for example, channel correction functions compensating for interference in the signal caused by the radio channel by utilizing information on the channel obtained from a known training sequence, A/D converters converting an analogue signal into a digital one by sampling and quantizing the base band signal, D/A converters converting a digital signal to an analogue one by a reverse method, filters at the receiver which filter frequencies outside a desired frequency band or, which in band-restricted systems restrict the band width of the output at the transmitter, and coding and decoding means for both channel and speech coding.

In this example, the controller block includes a voltage up-converter, a voltage measurement device and a transmission power adjusting circuitry for carrying out embodiments of the transmission method described in connection with FIG. 2.

The controller may include one or more digital signal processors provided with suitable software or it may be implemented by using separate logic circuits, such as ASICs (Application Specific Integrated Circuit). The controller may also be a combination of these two implementations, such as a processor with suitable software embedded within an ASIC.

Furthermore, in spread-spectrum systems, such as WCDMA, the spectrum of the signal is spread at the transmitter by means of a pseudorandom spreading code over a wide band and despread at the receiver, in an attempt to increase channel capacity. The control block also comprises means for arranging the signal to be transmitted and the signaling information to conform with the air interface standard of the cellular radio system used.

The user interface of the user device comprises a loudspeaker or an earpiece 510, a microphone 512, a display 516 and possibly a keypad and/or a joystick or a similar device. The user interface devices communicate with the control block.

The user device also comprises several different memory elements that are shown as one functional block 518.

The communication device typically comprises a battery 304 for power supply.

It is obvious to a person skilled in the art that the electronic device may include parts not depicted in FIG. 5.

Even though the invention has been described above with reference to an example according to the accompanying drawings, it is clear that the invention is not restricted thereto but it can be modified in several ways within the scope of the appended claims.

1. A transmission method, comprising:
setting a limiting value for a power supply voltage of an electronic device;
monitoring the power supply voltage and a transmission power need; and
if the power supply voltage drops below the limiting value, adjusting a transmission power according to the power supply voltage and the transmission power need for prolonging an operation time of the electronic device.

2. The method of claim 1, further comprising:
setting an upper limit for the transmission power need; and
adjusting the transmission power according to the power supply voltage and the transmission power need when the transmission power need is at least the same as the upper limit.

3. The method of claim 1, further comprising:
adjusting the transmission power within a range of a predetermined power level.

4. The method of claim 1, further comprising:
ramping up the transmission power gradually for avoiding energy consumption peaks.

5. An apparatus, comprising:
a monitor configured to monitor a power supply voltage and a transmission power need; and
a circuit configured to adjust a transmission power according to the power supply voltage and the transmission power need for prolonging operation time of an electronic device when the power supply voltage is at least the same as a predetermined limiting value set for a power supply voltage of the electronic device.

6. The apparatus of claim 5, wherein said circuit is further configured to adjust the transmission power according to the power supply voltage and the transmission power need when the transmission power need is at least the same as a predetermined upper limit set for the transmission power need.

7. The apparatus of claim 5, wherein said circuit is further configured to adjust the transmission power within a range of a predetermined power level.

8. The apparatus of claim 5, wherein said circuit is further configured to ramp up the transmission power gradually for avoiding energy consumption peaks.

9. A module, comprising:
a monitor configured to monitor a power supply voltage and a transmission power need; and
a circuit configured to a adjust transmission power according to the power supply voltage and the transmission power need for prolonging operation time of an electronic device when the power supply voltage is at least the same as a predetermined limiting value set for a power supply voltage of the electronic device.

10. The module of claim 9, wherein said circuit is further configured to adjust the transmission power according to the power supply voltage and the transmission power need when the transmission power need is at least the same as a predetermined upper limit set for the transmission power need.

11. The module of claim 9, wherein said circuit is further configured to adjust the transmission power within a range of a predetermined power level.

12. The module of claim 9, wherein said circuit is further configured to ramp up the transmission power gradually for avoiding energy consumption peaks.

13. An apparatus, comprising:
monitor means for monitoring a power supply voltage and a transmission power need; and
adjustment means for adjusting a transmission power according to the power supply voltage and the transmission power need for prolonging operation time of an electronic device when the power supply voltage is at least the same as a predetermined limiting value set for a power supply voltage of the electronic device.

14. The apparatus of claim 13, wherein said adjustment means is further configured for adjusting the transmission power according to the power supply voltage and the transmission power need when the transmission power need is at least the same as a predetermined upper limit set to the transmission power need.

15. A module comprising:
monitor means for monitoring a power supply voltage and a transmission power need; and
adjustment means for adjusting a transmission power according to the power supply voltage and the transmission power need for prolonging operation time of an electronic device when the power supply voltage is at least the same as a predetermined limiting value set for a power supply voltage of the electronic device.

16. The module of claim 15, wherein said adjustment means is further configured for adjusting the transmission power according to the power supply voltage and the transmission power need when the transmission power need is at least the same as a predetermined upper limit set for the transmission power need.

17. The method of claim 1, further comprising:
repeating monitoring and adjusting for operating the electronic device until the electronic device is switched off.
